(19) United States
(12) Patent Application Publication
(10) Pub. No.: US 2005/0271196 A1
(43) Pub. Date: Dec. 8, 2005

(54) Network support for blocking calls based on calling party category

(76) Inventors: Cynthia Florkey, Chicago, IL (US); Ruth Schaefer Gayde, Naperville, IL (US); John Richard Rosenberg, Elmhurst, IL (US)

Correspondence Address: Lucent Technologies Inc.;Docket Administrator - Room 3J-219, 101 Crawfords Corner Road, Holmdel, NJ, 07733-3030, US

(21) Appl. No.: 10/858,957

(22) Filed: Jun. 2, 2004

(51) Int. Cl. H04M 3/42

(52) U.S. Cl. 379/210.02

(57) ABSTRACT

Network support for blocking certain categories of calls, such as telemarketer calls, is disclosed. One or more network-based call control elements such as may reside within a mobile switching center or central office switch, effects blocking of calls based at least in part on the calling party category. A first call control element receives indicia of a prospective call and determines the calling party category. The first call control element sends a message including indicia of the calling party category to a second call control element, which blocks the prospective call based at least in part on the calling party category. Blocking may occur at the second call control element substantially independently (i.e., without regard to called party preferences) or after querying a subscriber database to determine called party preferences.

### FIELD OF THE INVENTION

This invention relates generally to the field of telecommunication systems and, more particularly, to a system and methods for blocking calls such as telemarketer calls based on calling party category.

### BACKGROUND OF THE INVENTION

Communication systems are well known in which persons (using, for example, wireless or wireline phones) may receive telephone calls from other persons or devices calling the called party phone. Often, these calls are unwelcome telemarketer or solicitation calls from a business or organization. Call screening mechanisms (e.g., answering machines) and alerting mechanisms (e.g., caller ID) are helpful at times to provide the called party the source or nature of the call (and so informed, the called party may choose to avoid certain calls) but these mechanisms do not necessarily identify telemarketer calls because telemarketers often “abandon” calls without leaving a message and can block or spoof caller ID. In any case, call screening and alerting mechanisms do not prevent ringing of the called party phone and telemarketers often make repeated attempts to call the party. Thus, even if a called party is able to avoid answering telemarketer call(s), the party is burdened by repeated ringing of the phone, often at inopportune times. Not surprisingly, therefore, it is not uncommon for persons to desire to prevent or block telemarketer calls, or at least certain types of telemarketer calls, from ringing their phone.

In the United States, legislation is in effect that legally prohibits certain telemarketer calls, but the legislation does not provide for blocking calls; it merely imposes fines when such calls occur. For example, it is unlawful for telemarketers to call telephone numbers associated with cellular or mobile radio service for which the subscriber would be charged for the call. However, due to number portability (i.e., where a subscriber may use a phone number previously assigned to a wireline phone for a wireless phone), telemarketers cannot necessarily determine if a called number is associated with a wireless or wireline phone. Hence, telemarketer calls may still occur.

As another example, the Federal Trade Commission (FTC) has implemented a national “do-not-call” list that is intended to restrict telemarketing calls by imposing fines on telemarketers who call persons having registered on the do-not-call list. However, the FTC system grants exceptions for certain types of businesses including, for example, airlines, banks, telephone companies and charities; businesses calling from within the same state; businesses who have sold, leased or rented anything to the called party within the last 18 months; and businesses who have received an inquiry or application from the called party during the past 3 months. Even when exceptions do not apply under the FTC system, telemarketer calls may still occur because the burden is on the telemarketer to check the registry if it wishes to avoid the fine.

Accordingly, there is a need for network-based blocking of calls based on category such that calls from a blocked category or categories (e.g., telemarketer calls) do not ring a called party phone. In such manner, blocking of telemarketer calls may be accomplished in compliance with applicable laws without relying on vigilance of the telemarketer to determine whom they are allowed to call. Advantageously, the methods will support blocking of all telemarketer calls directed to wireless phones and/or selective blocking of certain types of calls based on user preferences.

### SUMMARY OF THE INVENTION

This need is addressed and a technical advance is achieved in the art by a feature whereby a network-based call control element, such as a mobile switching center or central office switch, effects blocking of calls based on category. Alternatively, blocking may occur substantially on calling party category only (i.e., block all telemarketer calls arriving at the switch) or based on calling party category and called party preferences (block certain types of calls based on user preferences).

Generally, the system and method embodiments of the invention provide for receiving indicia of a prospective call from a calling party to a called party; determining a calling party category associated with the calling party; and blocking the prospective call based at least in part on the calling party category. In one embodiment, there is provided a method performed by one or more call control elements residing within, for example, mobile switching center or central office switches. A first call control element associated with the calling party receives indicia of the prospective call and determines the calling party category. The first call control element sends a message including indicia of the calling party category to a second call control element associated with the called party. The second call control element blocks the prospective call based at least in part on the calling party category. The blocking may occur at the second call control element substantially independently (i.e., without regard to called party preferences) or after querying a subscriber database to determine called party preferences.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method for blocking calls based on calling party category according to an embodiment of the present invention;

FIG. 3 is a message sequence chart associated with a telemarketer call being blocked by a network element based on calling party category; and

FIG. 4 is a message sequence chart associated with a telemarketer call being blocked by a network element based on calling party category and called party preferences.

### DESCRIPTION OF THE PREFERRED EMBODIMENT(S)

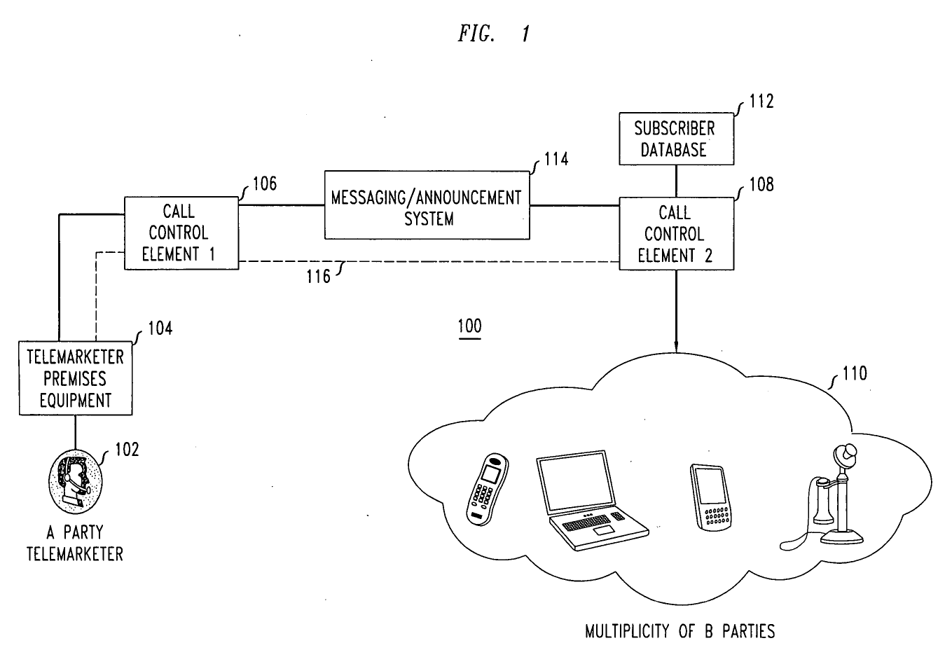

FIG. 1 shows by way of example and not limitation, a communication system 100 in which embodiments of the present invention may be implemented. Calling party 102 (as shown, a telemarketer, party “A”) is operably connected to customer premises equipment 104. The customer premises equipment 104 may comprise, for example, a call center, PBX or Automatic Call Distribution (ACD) equipment. The customer premises equipment 104 is operably connected to one or more call control elements (as shown, two elements 106, 108).

The call control elements 106, 108 may comprise, for example, a central office switch or access tandem such as a 5ESS® switching system and adjunct processors commonly residing in the Public Switched Telephone Network (PSTN); and/or a mobile switching center (MSC) such as an AUTOPLEX™ switching system, each available from Lucent Technologies, Inc. The call control elements 106, 108 include a memory and processor (not shown), for storing and executing software routines for processing and switching calls and for providing various call features to calling or called parties. The call control elements 106, 108 may be configured for operation with generally any suitable circuit, cell, or packet switching and routing technologies, including but not limited to Internet Protocol (IP) and Asynchronous Transfer Mode (ATM) technologies. The control elements are connected by links 114, 116, whereby link 114 denotes bearer traffic (e.g., voice, video or image data) and link 116 denotes control traffic (e.g., inter-node signaling such as SS7 ISUP or SIP protocols). As will be appreciated, the links 114, 116 are logical links that may be physically realized, without limitation, by T1 carrier, optical fiber, ATM links, wireless links, and the like.

Call control element 108 is operably connected to a plurality of communication devices 110 (as shown, a wireless phone, laptop, PDA and POTS phone). The type of connection may comprise, without limitation, conventional subscriber lines, ISDN lines, Ethernet LAN, and the like and will generally differ depending on the type of communication device 10. For example, in the case of a wireless phone, the phone communicates via wireless resources with a base station (not shown); and the base station, in turn, is connected via wireline or wireless link to the call control element 108. As will be appreciated, any of the communication devices 110 are prospective targets of telemarketer calls from calling party 102. In such case, call control element 108 defines a “terminating” element because it is the call control entity that serves the called party device 110; and call control element defines an “originating” element because it is the call control entity that serves the calling party device. The originating and terminating elements will generally differ for different combinations of calling and called parties, and it is possible that a single call control element serves as both originating and terminating element.

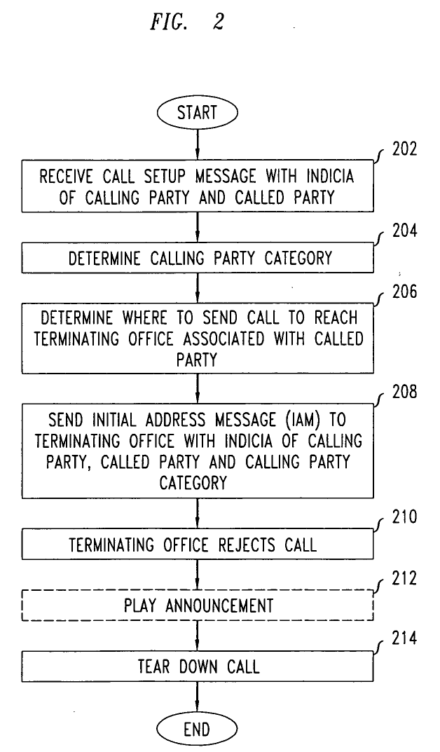

According to principles of the present invention, the telemarketer calls may be blocked, based on their category, by the terminating element (in the present example, by call control element 108) before reaching the respective communication devices 110. As will be described in greater detail in relation to FIGS. 2-4, the invention presumes that the originating element is able to identify the calling party category and communicate the calling party category to the terminating element. Blocking may occur at the terminating element substantially based on calling party category only—for example, call control element 108 may comprise an MSC that blocks all telemarketer calls arriving at the switch; or based on a combination of calling party category and called party preferences.

In the embodiment where call blocking is based in part on called party preferences, the terminating element is operably connected to a subscriber database 112 that includes information about various subscriber preferences (i.e., which devices 110 subscribe to a blocking service and which categories of calls the subscribers desire to be blocked). The categories of calls that are to be blocked may differ for different subscribers or at different times.

As shown, call control element 108 is further operably connected to a messaging/announcement system 114 for selecting and playing pre-recorded announcements, as may be appropriate, to calling or called parties. For example, the call control element 108 upon blocking a telemarketer call may cause the messaging system 114 to play an announcement informing the calling party 102 that the call is blocked.

Turning now to FIG. 2, there is shown a flowchart of a method for blocking calls based on calling party category. The steps of FIG. 2 will be described with reference to the communication system shown in FIG. 1. The steps of FIG. 2 are implemented, where applicable, using stored software routines within call control element 106 (“originating element”) and/or call control element 108 (“terminating element”). The method presumes that calling party 102 (“telemarketer, party A”) dials a directory number of a called party 110 (“party B”) to initiate a call to the called party device. The telemarketer's customer premises equipment 104 sends a SETUP message to the originating element including indicia of the called party number and calling party number (possibly a main PBX number). Messages to, from and between call control elements 106, 108 are presumed for purposes of example and not limitation to be in ISDN User Part (ISUP) protocol.

At step 202, the originating element receives the SETUP message with indicia of the calling and called party numbers. At step 204, the originating element determines the calling party category. In one embodiment, the originating element maintains a database of directory numbers associated with different calling party categories including, for example, a “telemarketer” category or multiple types of telemarketer categories. As will be appreciated, the categories may be broadly defined (e.g., “telemarketer” or “non-telemarketer”) or may be narrowly defined (e.g., “telemarketer” may be sub-categorized by type of business or service). To that end, it is contemplated that telemarketers will be legally mandated (or alternatively, will police themselves) to self-identify their directory numbers and further identify which numbers are used for which purpose; and this information is stored in the database to enable the originating element to determine the calling party category from the calling party directory number. Alternatively, the telemarketers might self-identify their category or categories in the SETUP message. As will be appreciated, the implementation details of which telemarketers/categories will be required to self-identify, which categories are to be used, how this information is communicated to the originating element and so forth are factors that may vary for different jurisdictions or at different times. Suffice it to say that the originating element will identify the calling party category in some fashion at step 204.

At step 206, the originating element determines the route needed to send a message/call to the terminating element associated with the called party. The route may be determined, for example, by the originating element consulting a database to determine which trunk group is associated with an area code of the called party, as is known in the art. Alternatively or additionally, the originating element might determine the particular terminating element associated with the called party. However, in switching networks, the originating element generally does not know the terminating element associated with the called party, only the route it would use to send a call there. Further, the originating element generally does not know how (or care) that there could be many intervening hops before the call actually gets to the terminating element or end user.

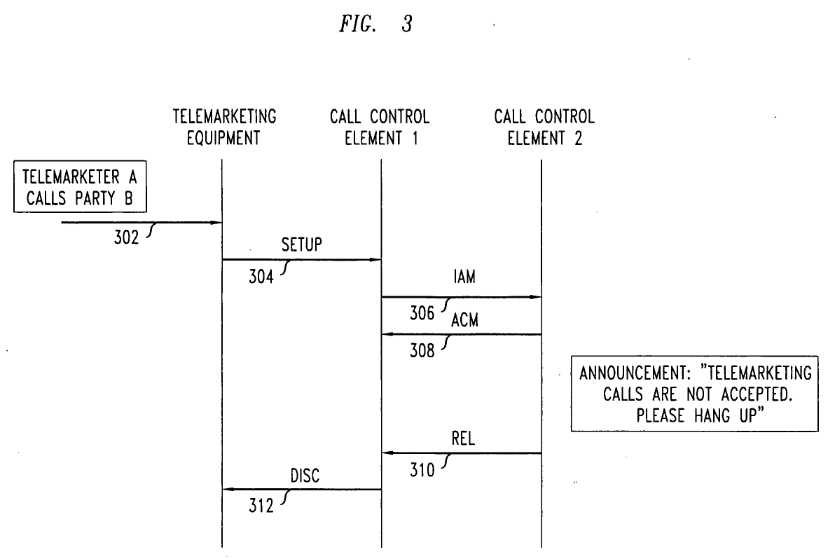

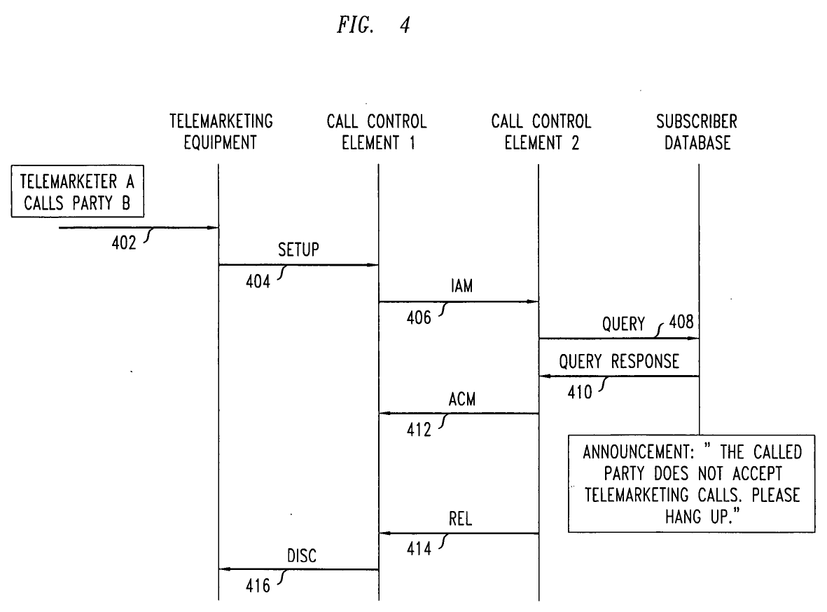

At step 208, the originating element sends an Initial Address Message (IAM) to the terminating element with indicia of the calling and called party numbers and the calling party category. For purposes of example, it is presumed the calling party category is “telemarketer” (or a certain sub-category of telemarketer) and, based at least in part on this category, the terminating element rejects the call at step 210. Blocking may occur at the terminating element substantially based on calling party category only—for example, call control element 108 may comprise an MSC that blocks all telemarketer calls arriving at the switch (FIG. 3); or based on a combination of calling party category and called party preferences (FIG. 4). In the former case, the terminating element consults a database to determine—substantially independently of user preferences—that the calling party category should be blocked. In the latter case, the terminating element queries a subscriber database to determine, based on the calling party category and subscriber preferences, whether the call should be blocked.

Optionally, at step 212, the terminating element causes the messaging system 114 to play an announcement informing the calling party 102 that the call is blocked. In one embodiment, the terminating element sends an Address Complete Message (ACM) to the originating element indicating that it is going to play an announcement. At step 214, the call is torn down. In one embodiment, the terminating element sends a RELEASE message to the originating element, causing the originating element to initiate tear down of the call in the backward direction.

Alternatively, at step 212, the announcement informing the calling party 102 that the call is blocked could be played by the originating element. In such case, instead of an ACM, the terminating element sends a RELEASE message to the originating element with a new “cause value” causing the announcement to be played by the originating element.

FIG. 3 is a message sequence chart associated with a telemarketer call being blocked by a terminating element based on calling party category. For example, the message sequence of FIG. 3 may be used in the case where the terminating element comprises a mobile switching center (MSC)—and the MSC blocks all telemarketer calls to wireless subscribers served by the MSC to ensure compliance with applicable laws. For purposes of example and not limitation, the messages shown in FIG. 3 are ISUP messages.

The message sequence is initiated by message 302 when telemarketer A places a call to party B. Message 302 comprises a signaling message sent from a calling terminal of telemarketer A to telemarketing premises equipment (e.g., PBX). Responsive to the message 302, the telemarketer premises equipment sends a SETUP message 304 to its serving call control element, call control element 1. The SETUP message contains CdPN=B (called party number=B) and CgPN=A (calling party number=A). The calling party number A may comprise, for example, a unique directory number of the calling terminal used by telemarketer A; or possibly a main PBX number associated with the telemarketing premises equipment. For purposes of example, it is presumed that call control element 1 determines from its internal database that the calling party number A is a telemarketer. Call control element 1 hence identifies the calling party category (CPC) as “telemarketer.”

Call control element 1 identifies from the called party number the terminating element, call control element 2, associated with the called party; and sends an Initial Address Message (IAM) 306 to call control element 2. The IAM message contains CdPN=B, CgPN=A and CPC=Telemarketer. For purposes of example, it is presumed call control element 2 does not allow incoming calls from CPC=Telemarketer. Call control element 2 sends to call control element 1 an Address Complete Message (ACM) 308 indicating that it is going to play an announcement.

Call control element 2 then plays an announcement such as “Telemarketing calls are not accepted. Please hang up.” Following the announcement, call control element 2 sends a RELEASE message 310 to call control element 1. Call control element 1 then initiates tear down of the call by sending a DISCONNECT message 312 to the telemarketing equipment.

FIG. 4 is a message sequence chart associated with a telemarketer call being blocked by a terminating element based on calling party category and called party preferences. For example, the message sequence of FIG. 4 may be used in the case where certain customers subscribe to a blocking service and wish to block telemarketer calls (or certain categories of telemarketer calls). For purposes of example and not limitation, the messages shown in FIG. 4 are ISUP messages.

The message sequence is initiated by message 402 when telemarketer A places a call to party B. Message 402 comprises a signaling message sent from a calling terminal of telemarketer A to telemarketing premises equipment (e.g., PBX). Responsive to the message 402, the telemarketer premises equipment sends a SETUP message 404 to its serving call control element, call control element 1. The SETUP message contains CdPN=B and CgPN=A. The calling party number A may comprise, for example, a unique directory number of the calling terminal used by telemarketer A; or possibly a main PBX number associated with the telemarketing premises equipment. For purposes of example, it is presumed that call control element 1 determines from its internal database that the calling party number A is a telemarketer. Call control element 1 hence identifies the calling party category (CPC) as “telemarketer.”

Call control element 1 identifies from the called party number the terminating element, call control element 2, associated with the called party; and sends an Initial Address Message (IAM) 406 to call control element 2. The IAM message 406 contains CdPN=B, CgPN=A and CPC=Telemarketer. For purposes of example, it is presumed call control element 2 allows some telemarketer calls but blocks certain calls based on customer preferences stored in a subscriber database. To query the subscriber database, call control element 2 sends to the subscriber database a query message 408; in turn, the subscriber database sends to call control element 2 a query response message 410. For purposes of example, it is presumed that the subscriber database indicates that party B does not accept telemarketer calls; and hence, the query response includes indicia that telemarketer calls are not allowed to party B. Call control element 2 sends to call control element 1 an Address Complete Message (ACM) 412 indicating that it is going to play an announcement.

Call control element 2 then plays an announcement such as “The called party does not accept telemarketing calls. Please hang up.” Following the announcement, call control element 2 sends a RELEASE message 414 to call control element 1. Call control element 1 then initiates tear down of the call by sending a DISCONNECT message 416 to the telemarketing equipment.

The present disclosure therefore has identified various elements, methods and message sequences for implementing blocking of calls such as telemarketer calls based on calling party category. The disclosure has identified method and message sequences that support blocking of all calls of a certain category, such as telemarketer calls, at a terminating element such as a mobile switching center; and blocking of certain calls based on a combination of category and subscriber preferences.

As will be appreciated, the present invention may be embodied in other specific forms without departing from its spirit or essential characteristics. For example, the invention may be implemented to block categories of calls other than or in addition to telemarketer calls, or may be implemented to block certain types or categories of calls at different times. The invention may be used to block calls (or messages), including but not limited to voice, video, data, image and text messages based on calling (or sending) party category. The invention may be implemented with network elements including but not limited to switches, routers or servers with virtually any suitable type of message/signal format between network elements.

The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising:
receiving indicia of a prospective call from a calling party to a called party;
determining a calling party category associated with the calling party; and
blocking the prospective call based at least in part on the calling party category.

2. The method of claim 1, performed by one or more call control elements, the method comprising:
receiving, at a call control element associated with the calling party defining a first call control element, the indicia of the prospective call;
determining, by the first call control element, the calling party category;
sending, from the first call control element to a second call control element associated with the called party, a message including at least indicia of the calling party category; and
based at least in part on the calling party category, blocking the prospective call by the second call control element.

3. The method of claim 2, wherein the step of receiving indicia comprises receiving, by the first call control element, a call setup message including a calling party directory number and a called party directory number.

4. The method of claim 3, wherein the step of determining the calling party category comprises consulting a database to identify a calling party category associated with the calling party directory number.

5. The method of claim 3, wherein the step of sending a message from the first call control element to the second call control element is preceded by a step of determining a routing path for sending the message from the first call control element to the second call control element.

6. The method of claim 3, wherein the step of sending a message comprises sending, from the first call control element to the second call control element, an initial address message including the calling party directory number, the called party directory number and the calling party category.

7. The method of claim 3, wherein the step of blocking comprises:
consulting a database associated with the second call control element to determine if the calling party category should be blocked; and
blocking the call if the database indicates the calling party category should be blocked.

8. The method of claim 3, wherein the step of blocking comprises:
querying a subscriber database including indicia of called party preferences to determine if the calling party category should be blocked; and
blocking the call if the subscriber database indicates the calling party category should be blocked.

9. The method of claim 1, wherein the step of blocking comprises blocking telemarketing calls.

10. The method of claim 1, further comprising playing a message to the calling party indicating that the prospective call is being blocked.

11. A system that provides for blocking calls based on category, the system comprising:
means for receiving indicia of a prospective call from a calling party to a called party;
means for determining a calling party category associated with the calling party; and
means for blocking the prospective call based at least in part on the calling party category.

12. The system of claim 11, wherein
the means for determining a calling party category comprises a first call control element associated with a calling party; and
the means for blocking comprises a second call control element associated with the called party.
